(19) United States
(12) Patent Application Publication
(10) Pub. No.: US 2023/0223532 A1
(43) Pub. Date: Jul. 13, 2023

(54) Electrochemical Cell and Electrochemical System

(71) Applicant: TDK Electronics AG, Munich (DE)

(72) Inventors: Dr. Yongli Wang, Frauental (AT); Masahiro Oishi, Kawasaki-shi (JP)

(21) Appl. No.: 17/997,077

(22) PCT Filed: Jun. 2, 2021
(86) PCT No.: PCT/EP2021/064773

§ 371 Date: Oct. 25, 2022

(30) Foreign Application Priority Data
Jun. 4, 2020 (DE) 10 2020 114 893.3

(51) Int. Cl. H01M 4/58; H01M 4/04; H01M 10/0562; H01M 10/0525

(52) U.S. Cl. CPC H01M 4/5825; H01M 4/0404; H01M 4/0471; H01M 10/0562; H01M 10/0525; H01M 2004/021

(57) ABSTRACT

In an embodiment an electrochemical cell includes a first electrode having a first surface area A1, a second electrode having a second surface area A2, an electrolyte arranged between the first electrode and the second electrode, wherein the electrochemical cell is configured to provide a first electrochemical half-cell reaction at the first electrode and provide a second electrochemical half-cell reaction at the second electrode, and wherein a surface area ratio A1/A2 is larger than a stoichiometric ratio of the first half-cell reaction and the second half-cell reaction.

This patent application is a national phase filing under section 371 of PCT/EP2021/064773, filed Jun. 2, 2021, which claims the priority of German patent application 102020114893.3, filed Jun. 4, 2020, each of which is incorporated herein by reference in its entirety.

### TECHNICAL FIELD

High performance electrochemical systems such as batteries are required in view of a growing demand in storage of renewable energy.

### BACKGROUND

Further, applications in, for example, electromobility or electronic applications require electrochemical storage systems which fulfil high security standards while offering high capacities and discharge rates.

For example, all-solid-state-batteries allow for storage of electric energy without the risk of leakage of liquid electrolyte.

Typically any electrochemical cell is built with respect to the chemical stoichiometric of the half-cell reactions.

For example, a generalized electrochemical reaction scheme may be represented by the following formulas:

First half-cell reaction: X≈x e⁻+X^{x+}

Second half-cell reaction: Y≈y e⁻+Y^{y+}

Electrochemical sum-reaction: y X+x Y^{y+}≈y X^{x+}+x Y

Conventionally, to take into account the stoichiometry of the reaction, the quantities of the electrode materials are adapted to the number of electrons produced in each half cell reaction.

This means, for a typical stoichiometric cell that the ratio of the quantity M₁ of the electrode of the first half cell reaction to the quantity M₂ of the electrode of the second half cell reaction follows the following dependency:

Stoichiometric cell electrode ratio: M₁/M₂=y/x

However, in electrochemical systems the two electrochemical half-cell reactions often have different reaction kinetics. This means, for example, that the theoretical maximum discharge current of the half cells may differ severely.

In a case in which both half-cells are constructed according to stoichiometrics, which means that while having the same loading with a red/ox active component at stochiometrically adapted quantities of the electrode materials, the slower half-cell reaction dominates the overall electrochemical process.

An example for this case is disclosed, for example in the US-patent laid open publication US2015/0333366 A1. Here, a symmetric all-solid-sate battery is described, in which anode and cathode in the discharge reaction have the surface area, thickness and structure, as in each of the half-cell reactions one electron is exchanged. Thereby, the overall performance is dominated by the kinetically slower anode reaction.

For example, in the case of an all-solid-state battery as described in non-patent literature 1 (Kobayashi et. al., Electrochemistry Communications 12, 2010, pp. 894-896), this issue is addressed by varying the concentration of the red/ox active component to compensate for the difference in reaction rate of the two electrochemical half-cells. In particular, the red/ox active material lithium vanadium phosphate of both anode and cathode in the discharge reaction is embedded in an electrically conducting porous matrix such as carbon.

The slower kinetics of the anode in the discharge process are compensated by a higher load with the red/ox active component. This, however, particularly influences the layer thicknesses.

Therefore, such an approach is not easily realizable, for example, with cheap conventional multilayer ceramic process techniques including printing and typecasting processes.

### SUMMARY

Embodiments provide an electrochemical cell in which differences in reaction kinetics between the two half-cell reactions are compensated and which may be prepared by conventional multilayer ceramic processes.

Further embodiments provide an electrochemical system comprising of electrochemical cells.

As a first embodiment an electrochemical cell is provided in which a first electrochemical half-cell reaction takes place at a first electrode having a first surface area A₁, and a second electrochemical half-cell reaction takes place at a second electrode having a second surface area A₂. An electrolyte is arranged between the first electrode and the second electrode. Further, the surface area ratio A₁/A₂ ratio is larger than the stoichiometric ratio of the first and the second half-cell reaction.

In a case in which the first electrochemical half-cell reaction is slower or has the slower reaction kinetics, the larger, over-stoichiometric surface area A₁ of the first electrode can compensate for the slower reaction kinetics.

In particular diffusion processes at an interface, which means, for example, transition of ions from the electrode into the electrolyte, may be a rate-limiting step. The absolute rate of ions which cross an interface in a certain time depends on the reaction rate and the surface area. This means by increasing the surface area, the overall numbers of ions crossing an interface can be increased.

As a further embodiment the electrochemical cell can be of such nature that a first theoretical maximum specific current density j₁ of the first half-cell reaction is smaller than a second theoretical maximum specific current density j₂ of the second half-cell reaction.

The theoretical maximum specific current density of a half-cell reaction is the highest current per electrode area which can be applied to or released from an associated half-cell if measured relative to an idealized counter half-cell. Further the theoretical maximum specific current can be defined for a certain condition of the overall electrochemical cell. For example for the case of a battery this certain condition may be a specific voltage or a charging state. The idealized counter half-cell is not rate limiting and can be, for example, accessible in a three-electrode test setup comprising the half-cell to be investigated, an reference electrode and a counter electrode.

For example, the theoretical maximum specific current density can be a near short-circuit current, i.e. under vanishing load current conditions measured against a non-limiting counter electrode setup.

If j₁ is smaller than j₂ the over-stoichiometric surface area ratio A₁/A₂ can compensate for the difference in theoretical maximum specific current density. Thus, the overall number of electrons exchanged per time in the entire electrochemical cell can be higher than in a case in which A₁ were the same as A₂.

As a further embodiment the electrochemical cell can be designed such that the surface area ratio A₁/A₂ equals the theoretical maximum specific current density ratio j₂/j₁.

In other words, the ratio of the surface areas of the two half-cells of the electrochemical cell is inversely proportional to the associated theoretical maximum specific current densities of the first and the second electrochemical half-cell reaction.

This means, instead of normalizing to the number of electrons exchanged in each half cell reaction, the surface area ratio A₁/A₂ is adapted to the amount of electrons, i.e. the current which can be extracted in a certain time from an electrode under certain boundary conditions.

The theoretical maximum currents J₁ and J₂ can be defined for the first and the second electrochemical half-cell, respectively. Therein the following relationships may be defined: J₁=j₁×A₁, and J₂=j₂×A₂.

Typically, the overall current of the entire electrochemical cell is limited to the smaller of the J₁ or J₂.

This means by having A₁/A₂ equal to j₂/j₁ the theoretical maximum current J₁ of the first electrochemical half-cell can be equal to the theoretical maximum current J₂ of the second electrochemical half-cell.

Thus, the current which can be applied to or extracted from an electrochemical cell for a given overall area sum of both electrodes can be maximized to the largest possible extent by adapting the surface area ratio to the inverse theoretical maximum specific current density ratio.

As a further embodiment the electrochemical cell can be of such nature that that a theoretical maximum specific rated capacity C₁ of the first half-cell reaction is smaller than a theoretical maximum specific rated capacity C₂ of the second half-cell reaction.

Here and in the following theoretical maximum specific rated capacity can mean a number of electrons (as charge with unit coulomb) per surface area of an associated electrochemical half-cell which can be stored or released under certain boundary conditions. Such boundary conditions may be a certain specific current window or a specific voltage window.

For example, for the case of the electrochemical cell being a battery, C₁ can be the number of electrons which can be released at least with a certain maximum rate, i.e. in a certain specific current window from the first electrochemical half-cell.

Alternatively, also for the case of the electrochemical cell being a battery, C₁ may be the number of electrons which provide at least a certain voltage under certain discharge current conditions.

C₂ can be defined analogously for the second half-cell reaction.

Equivalent definitions of C₁ and C₂ can also be made for any electrochemical system other than a battery, for example such as a galvanic system or for an electrochemical capacitor which may, for example, underlie diffusion limitation processes.

As a further embodiment the electrochemical cell can be configured such that the surface area A₁/A₂ equals the theoretical maximum specific rated capacity ration C₂/C₁.

In principle equivalently to the above described case, instead of normalizing to the number of electrons exchanged in each half cell reaction, as is done in a stoichiometric electrode setup, the surface area ratio A₁/A₂ is adapted to the theoretical maximum specific rated capacity, i.e. to the amount of electrons which can be retrieved or injected under certain boundary conditions.

Thus, the overall rated capacity of the entire electrochemical cell can be maximized.

As a further embodiment the electrochemical cell can be configured such that the first electrode comprises a first red/ox active compound which participates in the first electrochemical half-cell reaction and the second electrode comprises a second red/ox active compound which participates in the second electrochemical half-cell reaction. Further, a normalized concentration of the first red/ox active compound in the first electrode can equal the normalized concentration of the second red/ox active compound in the second electrode. The normalized concentration of a red/ox active compound in an electrode is the molar concentration of this red/ox active compound in the associated electrode normalized by the number of electrons exchanged in the associated half-cell reaction.

This means that both electrodes may have the same loading with a red/ox active compound relative to the electrons exchanged in the overall electrochemical reaction of the cell.

In a case in which one electron is involved in each half-cell reaction the molar loading of both electrodes with a red/ox active compound is equal. For example the first electrode and the second electrode electrodes may consist exclusively of the first and the second red/ox active compound, which are assembled on a charge collector material each.

This allows for fabrication of the electrodes, for example by screen-printing in a conventional multilayer ceramic process

As a further embodiment the electrochemical cell can be configured such that the first electrode has the same surface morphology as the second electrode.

This means, for example, that the structuring of both electrode surfaces is identical. Thus tedious process techniques for example for nano-structuring of an electrode, to alter its surface area can be avoided. For example the surface of both electrodes may be mainly flat, which allows for preparation of the electrodes by simple and cheap screen-printing techniques. In particular for both electrodes even the same printing device may be applied, which causes both electrodes to have the same surface morphology.

Thus, in this case the surface area of the electrodes is steered solely by the dimensions of the electrodes, but not by their surface morphology.

As a further embodiment the electrochemical cell can be configured such that the first electrode has the same thickness as the second electrode.

Preferentially their extent within a plane is at least one order of magnitude larger than the extend perpendicular to this plane, i.e. the thickness. This means that the thickness has neglect able influence on the electrode area. This holds in particular for typical ceramic assemblies.

In particular in the case in which the loading with red/ox active compounds is equal in both half-cells and the surface morphologies of both electrodes are the same, having the same thickness for the first and the second electrode simplifies preparation by tape-casting or screen-printing methods, as no measures need to be taken to compensate for different thicknesses.

In a further embodiment the electrochemical cell can be configured such that first electrode consists of a first sub-electrode and a second sub-electrode and the first sub-electrode, the second sub-electrode and the second electrode have a flat shape and are assembled in parallel with regard to the electrode plane. In this embodiment the second electrode is then arranged above the first sub-electrode and the second sub-electrode is arranged on the same height next to the second electrode.

This means, for example, that electrodes with the same surface morphology, the same thickness and the same loading are provided as second electrode, first sub-electrode, and second sub-electrode. Further, the second electrode can face the first sub-electrode in a manner similar to the conventional design of a fully symmetric electrochemical cell, as for example presented in US patent US 2015/0333366 A1. However, in contrast to this case the second electrode may have a smaller area than the first sub-electrode. In addition the second sub-electrode can be formed on the same height as the second electrode. Preferentially, the second sub-electrode is smaller than the first sub-electrode. Together the first sub-electrode and the second sub-electrode form the first electrode, which means they have the same polarity.

As a further embodiment the electrochemical cell can be configured such that the first red/ox active compound and the second red/ox active compound are identical.

Such a configuration may advantageously be used, for example, for a battery in which, during charging, the overall electrochemical reaction is a disproportionation reaction in which the red/ox active compound in one half-cell reaction becomes oxidized and in the other it becomes reduced. In the associated discharge reaction there is then a comproportionation reaction in which the red/ox active compound is formed again in both half-cell reactions.

This can have the advantage that an electrolyte which is efficient for both half-cell reactions to be chosen, as in such systems often the same ions are exchanged.

In a further embodiment the electrochemical cell is an all-solid-state electrochemical cell, for example an all-solid-state battery.

In particular for all-solid-state electrochemical cells the previously described features can be applied most efficiently. This is in particular because all-solid-state electrochemical cells are typically prepared in conventional multilayer ceramic processes.

In a further embodiment the electrochemical cell can be configured such that the first and the second electrode are lithium vanadium phosphate electrodes assembled on a charge collector material. Further, in this embodiment the electrolyte is a lithium-conducting solid electrolyte such as, for example, lithium aluminum titanium phosphate. Further, the first electrode is an anode comprising Li₄V₂(PO₄)₃ which is oxidized in the first half-cell reaction. Further, the second electrode is a cathode comprising Li₂V₂(PO₄)₃ which is reduced in the second half-cell reaction.

These reactions can be the half-cell reactions of a Li-ion all-solid-state battery during discharge whereby in the net-reaction two equivalents of Li₃V₂(PO₄)₃ are formed.

Here, the phase transition of lithium ions from the anode to the solid electrolyte is the rate-limiting step. The overall reaction rate is thus typically limited concerning either theoretical maximum current density or theoretical maximum specific rated capacity to the anode reaction.

Typically the activity at the cathode side is two times that of the anode side. This difference in activity can be compensated by the electrode size.

For example, the electrochemical cell may be configured such that the surface area A₁ is twice the second surface area A₂.

In particular in the case of a lithium vanadium phosphate all-solid-state electrochemical cell, this ratio of surface areas is advantageous because it can compensate for the two times higher maximum specific rated capacity of the cathode with respect to the anode.

As another embodiment an electrochemical system is provided which consists of multiple electrochemical cells as described above which are stacked.

For example, in such an electrochemical system the internal electrodes with the same electrochemical function, for example such as all anodes, are preferentially contacted by one external electrode and the electrode of the individual electrochemical cells then become the internal electrodes of the electrochemical system.

In such an electrochemical system consisting of several stacked electrochemical cells, high capacities and overall discharge or charge currents can be reached. Further, in particular in the case of all-solid-state electrochemical cells, these can be easily produced by conventional multilayer ceramic processes.

In one embodiment the electrochemical system is configured such that the electrochemical cells are stacked with the same orientation and the electrolyte is arranged between two neighboring electrochemical cells of the same orientation.

Preferentially the electrodes of the individual electrochemical cells are electrochemically active on both electrode sides. For example the electrodes can be coated with an electrochemically active compound on both sides. In this case further electrochemical cells are formed between the originally stacked electrochemical cells, as electrolyte is also arranged between the original cells. These additional electrochemical cells have inverse orientation to the individual electrochemical cells which are stacked.

Thereby the overall capacity, charge density or maximum discharge current can be increased.

An electrochemical system, such as described above can be prepared by first providing a ceramic electrolyte slurry from a ceramic electrolyte powder, an organic solvent, a binder, a dispersive agent and a plasticize. From this then a preliminary solid electrolyte tape can be formed. On the preliminary solid electrolyte tape a preliminary electrode layer, comprising a preliminary electrochemically active layer can be formed, for example by screen-printing. For example, a charge collector layer is surrounded or embedded by the electrochemically active layer. Then the as printed tape may be cut into sheets. From this a sheet stack can be formed by stacking the sheets, one upon another and arranging a sheet of unprinted preliminary electrolyte tape on top and bottom.

Subsequently green chips can be cut from the stack. The green chips can then undergo a treatment to remove the binder, preferably by heating and under protective gas, to prevent oxidation. Subsequently the green chips can be sintered at elevated temperature, under reduced atmosphere, for example. On two opposing surface of the sintered chips, a first and as second external electrode are formed.

The design of the electrochemical system as described before allows for application of this simple process, which allows also for mass production.

### BRIEF DESCRIPTION OF THE DRAWINGS

In the following the invention is explained in greater detail on the basis of exemplary embodiments and the associated figures. The figures serve solely to elucidate the invention and are therefore only illustrated schematically and not in a manner true to scale. Individual parts may be illustrated in an enlarged manner or in a distorted manner in terms of their dimensions. Therefore neither absolute nor relative dimensions nor specifications can be inferred from the figures. Identical or identically acting parts are provided with identical reference signs.

FIG. 1 shows a first embodiment of an electrochemical cell in schematic cross-section;

FIG. 2 shows a second embodiment of an electrochemical cell in schematic cross-section;

FIG. 3 shows a third embodiment of an electrochemical cell in schematic cross-section;

FIG. 4 shows a fourth embodiment of an electrochemical cell in schematic cross-section;

FIG. 5 shows a fifth embodiment of an electrochemical cell in three orthogonal schematic cross-sections in FIGS. 5A and, B and a top view in FIG. 5C, wherein the electrolyte is omitted; and

FIG. 6 shows an embodiment of an electrochemical system.

### DETAILED DESCRIPTION OF ILLUSTRATIVE EMBODIMENTS

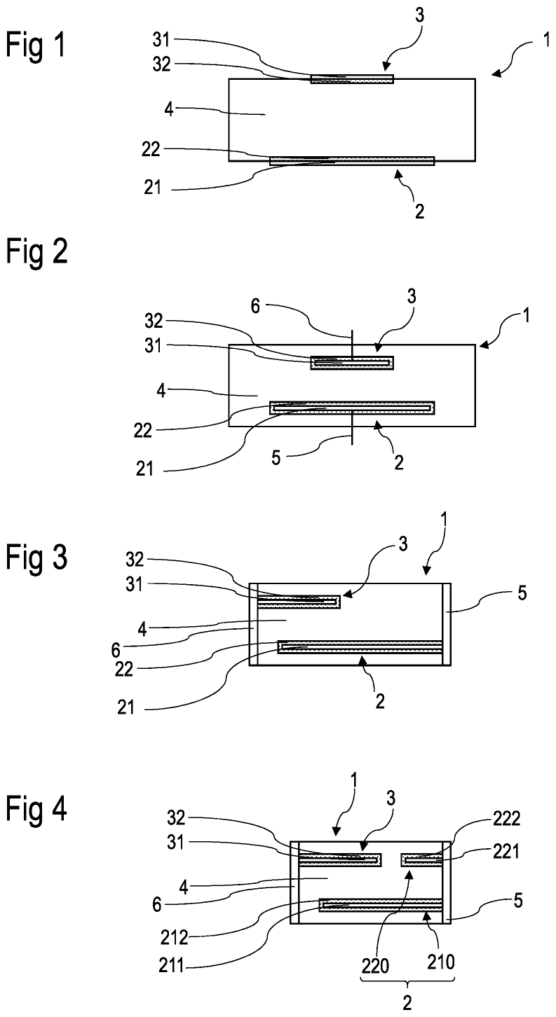

A first embodiment of an electrochemical cell 1 is displayed in a schematic cross-sectional view in FIG. 1. The electrochemical cell 1 comprises a first electrode 2 and a second electrode 3 facing each other and an electrolyte 4 arranged between both electrodes.

The shape of the electrochemical cell is not restricted. It can be for example cylindrical, or, preferentially, block shaped.

A first electrochemical half-cell reaction takes place at the first electrode 2 and a second electrochemical half-cell reaction takes at the second electrode 3.

Both electrodes 2 and 3 are plane electrodes.

The shape of the electrodes 2 and 3 is not limited in particular. For example, the electrodes may be of a circular shape, may be square-shaped or be of a rectangular shape.

Both electrode 2 and 3 comprise a charge collector layer 21 and 31 respectively. The charge collector layers 21 and 31 consist of a charge collector material which can be any suitable conductive material, for example Al, Cu, Pt, or preferentially copper.

Both electrodes 2 and 3 comprise an electrochemical active layer 22 and 32 of the first electrode 2 and the second electrode 3, respectively.

The electrochemically active layers 22 and 32 each comprise an electrochemically active material, of which they, preferentially, solely consist of.

The electrochemically active layers 22 and 32 are formed preferably as coating layers on the charge collector layers 21 and 31, respectively. In the present embodiment the electrochemically active layers 22 and 32 cover only one side of the charge collector layers 21 and 31. Due to this and due to the arrangement on the rim of the electrochemical cell 1, the charge collector layers 21 and 31 may be also employed as external electrodes in the present embodiment.

The electrochemically active materials of each of the electrochemically active layers 22 and 32 can be any material suitable of participating in an electrochemical reaction.

For example in the case of a wet electrochemical cell 1, the electrochemically active materials may be electro catalysts promoting the electrochemical reaction of the red/ox active compounds dissolved in a liquid electrolyte 4.

However, preferentially the electrochemical cell 1 is an all-solid-state electrochemical cell, with a solid electrolyte 4 and solid electrochemically active materials at the first and the second electrode 2 and 3.

In this case it is preferred that the red/ox active compounds are embedded in the electrochemically active layers 22 and 32. The degree of loading with the red/ox active compound in the electrochemically active layers 22 and 32 is identically.

A preferred example for such an all-solid-state electrochemical cell 1 is a lithium-vanadium-phosphate battery cell, with a Li-conducting solid electrolyte, such as Li_{1.3}Al_{0.3}Ti_{1.7}(PO₄)₃. There, the electrochemically active layers 22 and 32 consist of Li₃V₂(PO₄)₃ as electrochemically active material. In charged state, Li₄V₂(PO₄)₃ is present in the electrochemically active material of the first electrode 2, which is the anode of the discharge reaction and Li₂V₂(PO₄)₃ is present in the electrochemically active material of the second electrode 3, which is the cathode of the discharge reaction.

The discharge reaction at the anode (first half-cell reaction) is represented by:

Li₄V₂(PO₄)₃→Li₃V₂(PO₄)₃+Li⁺+e⁻

The discharge reaction at the cathode (second half-cell reaction) is represented by:

Li₂V₂(PO₄)₃+Li⁺+e⁻→Li₃V₂(PO₄)₃

The electrochemical sum-reaction, which is a comproportionation reaction, is thus represented by:

Li₄V₂(PO₄)₃+Li₂V₂(PO₄)₃→2 Li₃V₂(PO₄)₃

As is depicted in FIG. 1, the surface area A₁ of the first electrode is larger than the surface area A₂ of the second electrode. In particular, as depicted the surface area ratio A₁/A₂ can be 2/1 if both electrodes are formed, for example as stripes, with the same width.

This means for the case of a lithium-vanadium-phosphate battery cell as described above that the surface area surface area ratio A₁/A₂ exceeds the stoichiometric ratio of the electrodes which would be a 1:1 ratio, which corresponds to the conventional symmetric battery setup.

By having a surface area ratio of A₁/A₂=2/1, a theoretical maximum specific current density ratio j₂/j₁ of 2/1 can be fully compensated.

Alternatively a theoretical maximum specific rated capacity ratio C₂/C₁ of 2/1 can be fully compensated.

Generally for electrochemical systems the ratios j₂/j₁ and C₂/C₁ are not necessarily identical, though they often have the same tendency.

Often, if j₂>j₁ then also C₂>C₁. This means by fully compensating for either one of j₂/j₁ or C₂/C₁, the other preferentially may also become at least partly compensated.

This, in particular, may be found in the case of the above described type of lithium-vanadium-phosphate battery cell to have either a theoretical maximum specific current density ratio j₂/j₁ of 2/1 or a maximum specific rated capacity ratio C₂/C₁ of 2/1, depending on the parameter details for the cell and the discharge conditions.

This is due to the rate limiting step being the diffusion of Li⁺ from the anode into the solid electrolyte 4 during the discharge reaction.

However, in many cases j₂/j₁ at least roughly equals C₂/C₁ for lithium-vanadium-phosphate battery cells of the above type.

As depicted in FIG. 1 both electrodes 2 and 3 have the thickness and the same surface morphology, meaning that the surface morphology of electrochemically active layers 22 and 32 facing the electrolyte is mainly identical. Preferentially both electrodes have no structuring on the nanometer scale and can be considered as merely flat.

FIG. 2 shows a second embodiment of an electrochemical cell 1 in schematic cross section.

This second embodiment can be identical to the first embodiment as discussed above, except or the following details.

The first electrode 2 and the second electrode 3 are assembled not at the rim of the electrochemical cell 1, but are fully embedded in the electrolyte, and are thus internal electrodes.

Consequently, the charge conductor layers 21 and 31 of the first and the second internal electrode 2 and 3 is covered on both sides by the electrochemically active layers 22 and 32, respectively.

Thus the electrochemically active area of the electrodes can be increased as compared to a case of electrodes with same size, of which only one side is coated.

As the internal electrodes 2 and 3 are basically flat, the surface area is basically unaffected by the coating of the edges of the charge collector layers 21 and 31 by the electrochemically active layers 22 and 32, respectively.

To electrically contact the electrodes a first external electrode 5 leads to the charge collector layer 21 of the first internal electrode 2 and a second external electrode 6 leads to the charge collector layer 31 of the second internal electrode 3.

The external electrodes 5 and 6 can be of any suitable conductive material and are insulated against the electrolyte 4.

FIG. 3 shows a third embodiment of an electrochemical cell 1 in schematic cross section.

This third embodiment of an electrochemical cell 1 is block-shaped and is a lithium-vanadium-phosphate battery, similar to the one described with regard to the first exemplary embodiment, except for the following details.

A first external electrode 5 and a second external electrode 6 are arranged on opposing sides of the electrochemical cell 1. Preferably, the external electrodes 5 and 6 fully cover the sides of the electrochemical cell 1 they are arranged on.

The external electrodes 5 and 6 can be of any suitable electrically conducting material, for example they are Cr/Ni/Ag triple layers.

From the side of the first external electrode 5 the first internal electrode 2 extends into the Li-ion conducting solid electrolyte 4.

The second internal electrode 3 extends from the side of the second external electrode 6 into the electrolyte 4.

Both internal electrodes 2 and 3 are flat rectangular platelets of the same thickness, which face each other.

The charge collector layers 21 and 31 are in electrical contact with the external electrodes 5 and 6, respectively.

Forming the interface to the electrolyte, the charge collector layers 21 and 31 are entirely coated by the electrochemically active layers 22 and 32, respectively.

To compensate for the slower reaction kinetics of the first half-cell reaction at the first electrode compared to the second half cell reaction at the second electrode, the first electrode 1 area A₁ of the first electrode is larger than the second electrode area A₂ of the second electrode 3.

In particular, the area ratio A₁/A₂ is chosen to be 2/1, to compensate for the theoretical maximum specific current density j₂/j₁ or the theoretical maximum specific rated capacity ratio C₂/C₁, of which at least one, preferably is 2/1.

In the present embodiment the width of the internal electrodes 2 and 3 is identical. The internal electrodes 2 and 3 however differ in length, to generate the difference in surface area.

The third exemplary embodiment can be formed by any suitable process, but can be preferably formed by a conventional multilayer ceramic process.

To this end first a ceramic a homogeneous slurry is prepared from an electrolyte powder which is mixed with an organic solvent, a binder, a dispersive agent, and a plasticizer. The slurry is casted on a carrier tape to form a uniformly thick preliminary solid electrolyte tape.

Onto this preliminary solid electrolyte tape preliminary electrode layers are printed layer by layer, i.e. first a lithium-vanadium-phosphate layer, as a lower part of a preliminary electrochemically active layer, then a preliminary charge collector layer from a metal paste and again a lithium vanadium phosphate layer as an upper part of a preliminary electrochemically active layer.

The layers are cut and assembled such that the first and the second electrode are formed with the appropriate arrangement. At the top and the bottom unprinted preliminary electrolyte sheets are arranged.

Green chips are cut from the as described stacks. They undergo a debinding treatment and a subsequent sintering procedure. Both are carried out under reduced atmosphere or inert atmosphere to avoid oxidation.

Finally the external electrodes are formed on the side surfaces of the chips, for example by sputtering deposition of the Cr/Ni/Ag triple layers.

FIG. 4 shows a fourth embodiment of an electrochemical cell 1 in schematic cross section.

The fourth embodiment is identical to the third embodiment except for the arrangement of the internal electrodes 2 and 3.

The second electrode 3 is basically identical to the second electrode 3 of the third embodiment.

However, the first electrode 2 consists of a first sub-electrode 210 and a second sub-electrode 220.

Each of the first and the second sub electrode have a similar structure as the first electrode 2 of the third embodiment. Both extend from the side of the first external electrode 5 into the electrolyte and comprise each a charge collector layer 211 and 221, which is covered by an electrochemically active layer 212 and 222, respectively. All of the second electrode 3, the first sub electrode 210 and the second sub electrode 220 have the same thickness, surface morphology and loading with the redox active compound.

The second sub electrode 220 is the smaller of the sub-electrodes and is arranged on the same level in the electrochemical cell 1 as the second electrode 3. Both have the same orientation and face towards the first sub-electrode 210 which is arranged below in the electrochemical cell 1.

The electrode area of the first and the second sub-electrode together form the first electrode area A₁ of the second electrode 2, which underlies the same conditions in the third exemplary embodiment.

Preferentially, the internal electrodes 2 and 3 (or 210, 220 and 3) are arranged such within the electrochemical cell 1 that the cross sectional cutting plane of FIG. 4 forms a mirror plane, to which they are symmetric.

Having a second sub-electrode arranged on the same height as the second electrode allows for a denser packing of the electrodes in the electrochemical cell as compared to the third embodiment. In particular, by this stacking of electrodes the same packing density with electrodes and with the electrochemically active material as in a conventional symmetric cell can be achieved.

The fourth embodiment can be formed analogously to the third embodiment.

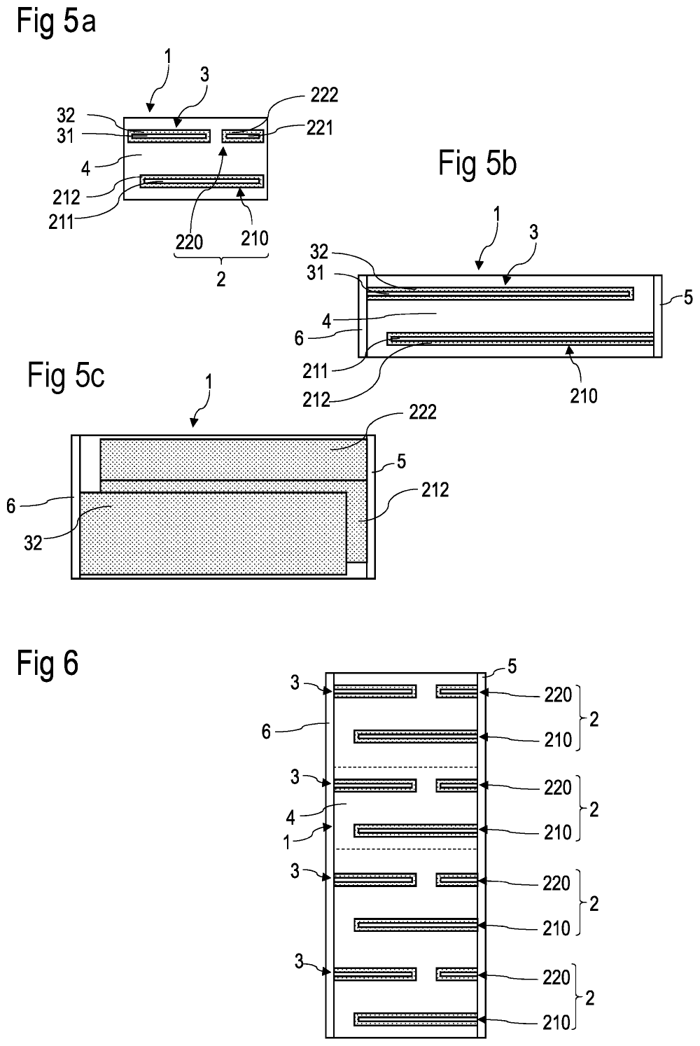

FIG. 5 shows a fifth embodiment of an electrochemical cell 1 in different schematic cross sectional views.

The fifth embodiment is identical to the fourth embodiment, except for the following details. In particular, the arrangement of the internal electrodes 2 and 3 (or 210, 220 and 3) differs as compared to the third embodiment.

FIG. 5c shows a schematic top view on the electrochemical cell, in which the electrolyte 4 is omitted in this view in FIG. 5c to show the other internal electrodes.

The second electrode 3 expands from the second external electrode 6 into the electrolyte 4, as can be also seen in the cross sectional view of FIG. 5b.

Both the first sub-electrode 210 and the second sub-electrode 220, which together form the first electrode 2 extend from the side of the first external electrode into the electrolyte.

As can be seen in FIGS. 5a-5c, the second electrode 3, the first sub-electrode 210 and the second sub-electrode 220 each have the same length, but differ in width.

The second sub-electrode 220 is arranged on the same level next to the second electrode 2. Both face the first sub-electrode 210 arranged below.

The advantages of this arrangement are mainly the same as for the fourth embodiment. However, this fifth arrangement allows for a slightly increased overlap between the second electrode and the first sub-electrode, which makes ion transport in the electrolyte more efficient.

The fifth embodiment can be formed analogously to the third embodiment.

By arranging electrodes as according to the third, fourth, or fifth embodiment the maximum current or the capacity which can be received may be up to 33% higher as in the case of a symmetrically designed conventional all-solid-state battery with same combined surface area of first and second internal electrodes.

FIG. 6 shows an embodiment of an electrochemical system according to the present invention.

This embodiment consists of four electrochemical cells 1 according to the fourth embodiment stacked one upon another with the same orientation to form the electrochemical system.

Thus, the electrochemical system is an all-solid-state multilayer Li-ion battery.

One of the electrochemical cells 1 is marked in FIG. 6 by dashed lines depicting upper and lower interface to the respective neighboring cell.

Between the stacked electrochemical cells 1 additional electrolyte 4 is arranged so that the distance of the first sub-electrodes 210 to all directly neighboring second electrodes 3 (and to all second sub-electrodes 220 on the same level) is identical.

Facing electrodes of opposing charge on both sides of one electrode increases the capacity of the system as compared to the sum of the individual electrochemical cells by optimizing the ion-transport distances through the electrolyte.

The external electrodes are formed on the entire surface of two opposing side surfaces of the electrochemical system.

By the same principle electrochemical systems of any desired size can be constructed by stacking of the necessary number of electrochemical cells 1.

Of course, instead of forming an electrochemical system from electrochemical cells of the fourth embodiment, also electrochemical cells of the third or the fifth embodiment can be stacked analogously.

The electrochemical system can be formed by a modified procedure similar to the one described for the third embodiment of an electrochemical cell.

First, a preliminary solid electrolyte tape is formed, on which a preliminary electrode layer of a certain pattern is formed. Therefore, first lower part of the preliminary electrochemically active layer is screen-printed. Subsequently a preliminary charge collector layer is screen printed, an upper part of the preliminary electrochemically active layer is screen-printed. Thus the preliminary charge collector layer is embedded in the preliminary electrochemically active layer. Then the as printed tape may be cut into sheets. From this a sheet stack can be formed by stacking the sheets one upon another, and arranging a sheet of unprinted preliminary electrolyte tape on top and bottom.

Subsequently, after an isostatic hot press procedure green chips can be cut from the stack. The green chips then undergo a treatment to remove the binder, preferably by heating to 700° C. and under protective gas, to prevent oxidation. Subsequently the green chips are sintered at elevated temperature, for example at 850° C., under reduced atmosphere. On two opposing surface of the sintered chips, a first and as second external electrode are formed, for example by sputter-deposition of metallic layers such as Cr/Ni/Ag triple layers.

Although the invention has been illustrated and described in detail by means of the preferred embodiment examples, the present invention is not restricted by the disclosed examples and other variations may be derived by the skilled person without exceeding the scope of protection of the invention.

1.-18. (canceled)

19. An electrochemical cell comprising:
a first electrode having a first surface area A1;
a second electrode having a second surface area A2;
an electrolyte arranged between the first electrode and the second electrode,
wherein the electrochemical cell is configured to:
provide a first electrochemical half-cell reaction at the first electrode, and
provide a second electrochemical half-cell reaction at the second electrode, and
wherein a surface area ratio A1/A2 is larger than a stoichiometric ratio of the first half-cell reaction and the second half-cell reaction.

20. The electrochemical cell according to claim 19, wherein the electrochemical cell is configured to provide the first electrochemical half-cell reaction with slower reaction kinetics than the second electrochemical half-cell reaction.

21. The electrochemical cell according to claim 20, wherein the larger, over-stoichiometric first surface area A1 is configured to compensate for the slower reaction kinetics.

22. The electrochemical cell according to claim 19, wherein the electrochemical cell is configured to provide a first theoretical maximum specific current density j1 of the first half-cell reaction that is smaller than a second theoretical maximum specific current density j2 of the second half-cell reaction.

23. The electrochemical cell according to claim 22, wherein the surface area ratio A1/A2 equals a theoretical maximum specific current density ratio j2/j1.

24. The electrochemical cell according to claim 19, wherein the electrochemical cell is configured to provide a theoretical maximum specific rated capacity C1 of the first half-cell reaction that is smaller than a theoretical maximum specific rated capacity C2 of the second half-cell reaction.

25. The electrochemical cell according to claim 24, wherein the surface area ratio A1/A2 equals a theoretical maximum specific rated capacity ratio C2/C1.

26. The electrochemical cell according to claim 19,
wherein the first electrode comprises a first red/ox active compound configured to participate in the first electrochemical half-cell reaction,
wherein the second electrode comprises a second red/ox active compound configured to participate in the second electrochemical half-cell reaction,
wherein a normalized concentration of the first red/ox active compound in the first electrode equals the normalized concentration of the second red/ox active compound in the second electrode, and
wherein the normalized concentration of a red/ox active compound in an electrode is a molar concentration of the red/ox active compound in an associated electrode normalized to a number of electrons exchanged in an associated half-cell reaction.

27. The electrochemical cell according to claim 19, wherein the first electrode has the same surface morphology as the second electrode.

28. The electrochemical cell according to claim 19, wherein the first electrode has the same thickness as the second electrode.

29. The electrochemical cell according to claim 26,
wherein the first electrode consists of a first sub-electrode and a second sub-electrode,
wherein the second electrode, the first sub-electrode and the second sub-electrode have a flat shape and are assembled in parallel with regard to an electrode plane,
wherein the second electrode is arranged in a height different to the first sub-electrode, and
wherein the second sub-electrode is arranged on the same height next to the second electrode.

30. The electrochemical cell according to claim 26, wherein the first red/ox active compound and the second red/ox active compound are identical.

31. The electrochemical cell according to claim 19, wherein the electrochemical cell is an all-solid-state electrochemical cell.

32. The electrochemical cell according to claim 19,
wherein the first electrode and the second electrode are lithium vanadium phosphate electrodes on a charge collector material,
wherein the electrolyte is a Li-conducting solid electrolyte,
wherein the first electrode is an anode comprising Li4V2(PO4)3, oxidizable in the first half-cell reaction, and
wherein the second electrode is an cathode comprising Li2V2(PO4)3, reduceable in the second half-cell reaction.

33. The electrochemical cell according to claim 32, wherein the first surface area A1 is twice the second surface area A2.

34. A electrochemical system comprising:
a plurality of electrochemical cells, each being the electrochemical cell according to claim 19,
wherein the electrochemical cells are stacked.

35. The electrochemical system according to claim 34,
wherein the electrochemical cells are stacked with the same orientation, and
wherein the electrolyte is arranged between two neighboring electrochemical cells of the same orientation.

36. A method for manufacturing an electrochemical system, wherein the electrochemical system comprises multiple first electrodes each having a first surface area A1, consisting of a first sub-electrode and a second sub-electrode, and the same number of second electrodes as the first electrodes, wherein each second electrode has a second surface area A2, wherein each first sub-electrode, each second sub-electrode and each second electrode comprises an electrochemically active layer of an electrochemically active material and a charge collector layer, wherein the multiple first and second electrodes are embedded into a solid electrolyte, wherein the charge collector layers of all first sub-electrodes and of all second sub-electrodes are in electrical contact with a first external electrode on a surface of the electrochemical system, and the charge collector layers of all second electrodes are in electrical contact with a second external electrode on a surface of the electrochemical system opposite to the first external electrode, wherein a first electrochemical half-cell reaction is able to take place at the first electrodes, and a second electrochemical half-cell reaction is able to take place at the second electrodes, and wherein a surface area ratio A1/A2 is larger than a stoichiometric ratio of the first and the second half-cell reaction, the method comprising:
providing a ceramic electrolyte slurry from a ceramic electrolyte powder, an organic solvent, a binder, a dispersive agent and a plasticizer;
forming of a preliminary solid electrolyte tape from the ceramic electrolyte slurry;
forming a preliminary electrode layer comprising a preliminary charge collector layer and a preliminary electrochemically active layer on the preliminary solid electrolyte tape;
cutting of the preliminary solid electrolyte tape with the preliminary electrode layer into sheets;
forming a sheet stack from multiple sheets and by arranging an solid electrolyte sheet without the preliminary electrode layer on a top and a bottom of the sheet stack;
cutting green chips from the sheet stack;
removing the binder by heating;
sintering the green chips; and
forming the first external electrode and the second external electrode on opposing surfaces of a chip.
